(19) United States
(12) Patent Application Publication
(10) Pub. No.: US 2005/0123315 A1
(43) Pub. Date: Jun. 9, 2005

(54) Heating device, fixing device using the heating device and image forming apparatus using the fixing device

(76) Inventors: Kazuhito Kishi, Yokohama-shi (JP); Yasuhisa Kato, Hiratsuka-shi (JP); Masami Okamoto, Yamato-shi (JP); Yasutada Tsukioka, Matsudo-shi (JP); Hiromasa Takagi, Edogawa-ku (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/004,928

(22) Filed: Dec. 7, 2004

(30) Foreign Application Priority Data
Dec. 8, 2003 (JP) 2003-408694

(51) Int. Cl. G03G 15/20; G03G 15/00

(52) U.S. Cl. 399/69; 399/88

(57) ABSTRACT

A heating device including a main power source; a sub power source including a capacitor capable of charging and discharging; a heating member including a main heater and an auxiliary heater and configured to heat a material with the heater and the auxiliary heater, wherein the main heater and the auxiliary heater are supplied with electric power by the main power source and the sub power source; and a sub power source controller configured to control the sub power source such that a temperature of the auxiliary heater is controlled so as to be a target temperature, wherein the sub power source controller changes the target temperature, if necessary. A fixing device and an image forming apparatus including the heating device are also provided.

### BACKGROUND OF THE INVENTION

1. Field of the Invention

The present invention relates to a heating device which heats various materials and devices, a fixing device which fixes a material (e.g., toner images) on a material (e.g., recording materials) using the heating device, and an image forming apparatus, such as copiers, printers and facsimiles, which forms a toner image on a recording material using the fixing device.

2. Discussion of the Background

In image forming apparatus such as copiers, printers and facsimiles, an image is formed on a recording material such as plain papers and overhead projection sheets. In view of image qualities and running costs, electrophotography is typically used as the image forming method. Electrophotographic image forming methods include the steps of forming a toner image on a recording material; and fixing the toner image on the recording material upon application of heat and pressure thereto.

As for the fixing method, heat roller fixing methods, which use a heat roller to fix a toner image, are typically used in view of safety. The heat roller fixing methods typically use a heat roller which is heated by a heat source such as halogen heaters, and a pressure roller which is in pressing-contact with the heat roller, thereby forming a nip therebetween. When a recording material bearing a toner image thereon is fed into the nip, heat and pressure are applied to the toner image, resulting in fixation of the toner image on the recording material.

Recently, environmental protection becomes a major issue, and energy-saving image forming apparatus (such as copiers and printers) have been developed. Therefore, when an image forming apparatus is developed, it is important to save energy used for fixing toner images on recording materials. Specifically, it is important to save energy used for a fixing device in a waiting state. Therefore, recently an energy-saving technique such that the temperature of a heat roller, which, in a waiting state, is controlled so as to be slightly lower than the predetermined fixing temperature, is rapidly increased to the fixing temperature at an image formation order is used so that users do not wait long for activation of the fixing device.

However, this technique has a drawback in that a considerable amount of electric power has to be supplied to the fixing device in a waiting state, resulting in consumption of excess energy. The energy used for a fixing device in a waiting state is considered to be from 70 to 80 percent of the total energy consumption of the image forming apparatus using the fixing device. Therefore, it is desired to reduce the energy consumption of a fixing device in a waiting state to further save energy of the image forming apparatus using the fixing device. In other words, it is ideal that the energy consumption of a fixing device is zero in a waiting state.

However, if the energy consumption of a fixing device in a waiting state is zero, it takes a long time of from few minutes to tens minutes to raise the temperature of the heat roller of the fixing device to a predetermined fixing temperature (about 180° C.), i.e., the fixing device has a long rise time. Therefore, this fixing device is not practical. Accordingly, a need exists for a fixing device in which the energy consumption thereof in a waiting state is as low as possible and the temperature of the heat roller can be rapidly raised to a predetermined fixing temperature.

It is clear that the rise time of a heat roller can be shortened by applying high energy to the heat roller per a unit time, i.e., by increasing the power rating of the fixing roller. In reality, some high speed image forming apparatus are used at an electric power of 200 V. However, the commercial electric power conditions are 100 V and 15 A in typical offices in Japan. Namely, a special electric construction is necessary for providing an electric power of 200 V. Therefore, this technique is not a general solution.

As mentioned above, it is difficult to shorten the rise time as long as a commercial power source of 100 V and 15 A is used. This is because the maximum energy applied to the fixing device, which depends on the commercial electric power, is relatively low. In order to solve the problem, published unexamined Japanese patent application No. (hereinafter referred to as JP-A) 10-10913 discloses a technique in that a relatively low voltage is constantly applied to a heat roller of a fixing device when the fixing device is in a waiting state, to prevent the temperature of the heat roller from dropping. In addition, JP-A 10-282821 discloses a technique in that a secondary battery serves as a sub power source is charged when a fixing device is in a waiting state, and a combination of electric powers of a main power source and the secondary battery (or a primary battery) is applied when a print order is made, to shorten the rise time.

However, since a low voltage is constantly applied to the fixing device during a waiting state of the fixing device disclosed in JP-A 10-10913, the fixing device does not fully save energy. In addition, since the electric power applied to the fixing device in the start-up time thereof is equal to the maximum power of the main power source of the image, the rise time is not so short.

In the fixing device disclosed in JP-A 10-282821, the main electric power source and a secondary battery (or a primary battery) apply an electric power to the fixing device in the start-up time. Batteries such as lead batteries, nicad batteries and nickel-hydrogen batteries are used as the secondary battery. The secondary batteries have a drawback in that the power decreases when charging and discharging are repeatedly performed. In particular, the life of secondary batteries is seriously shortened when the batteries discharge under a large current. In addition, second batteries have a drawback in that the capacity thereof deteriorates due to the memory effect thereof. Even in a case of a secondary battery having a longest life, the life thereof expires when charging and discharging are performed thereon 500 to 1000 times. Provided that charging and discharging are performed thereon 20 times in a day, the life thereof is about one month. Namely, the batteries have to be frequently exchanged, which is troublesome for users and resulting in increase in running costs. In addition, lead batteries are not suitable for office machines because of using sulfuric acid as an electrolyte.

Further, when a large electric power is supplied and stopped (i.e., current is rapidly changed and a large inrush current is applied) in the fixing device, the load to the electric circuit included in the heat roller of the fixing device is seriously increased and in addition a current is also applied to the circuits in the vicinity of the electric circuit. Thereby a problem in that noises are generated in the circuits occurs. Therefore, it is not preferable to frequently switch such an auxiliary power source. Furthermore, when a large amount of electric power is applied to the fixing device at a time (i.e., an excessive amount of electric power is applied), a problem in that the temperature of the heat roller of the fixing device excessively increases tends to occur.

In attempting to solve these problems, JP-A 2002-184554 discloses a fixing device which has a short rise time and good energy saving property while reducing the noises caused by the inrush current and rapid change of current during a start-up time and which does not cause the problem in that the temperature of the heat roller is excessively increased. Specifically, the fixing device includes a chargeable and dischargeable capacitor as a sub power source; a charger which charges the capacitor using an electric power supplied by the main power source; and a switching device which performs switching between application of an electric power to charge the sub power source and heating of the auxiliary heater using the power supplied from the sub power source, to adjust the electric power supplied by the sub power source. The primary function of the capacitor is to heat the auxiliary heater using an electric power supplied by the capacitor, resulting in shortening of the rise time of the temperature of the heat roller and prevention of decrease in the fixing temperature of the heat roller caused by successively fed paper sheets.

However, in the fixing device, the capacitor serves to heat the auxiliary heater every time until the heater has a predetermined temperature. Namely, whenever the main heater is not heated by a main power source, the auxiliary heater is heated by the sub power source to control the temperature of the heat roller. Therefore, the load to the sub power source is large because a large amount of current is switched.

In addition, it takes a time of from tens seconds to two minutes until the capacitor is charged so as to have a minimum discharging voltage, and the capacitor cannot be used in this period. Accordingly, it is desired to shorten the charging time.

Because of these reasons, a need exists for a fixing device which can rapidly increase the temperature of a heat roller at a relatively small amount of energy without causing the above-mentioned problems.

### SUMMARY OF THE INVENTION

The present invention provides a heating device including:
a main power source;
a sub power source including a capacitor capable of charging and discharging;
a heating member including a main heater and an auxiliary heater and configured to heat a material with the heater and the auxiliary heater, wherein the main heater and the auxiliary heater are supplied with electric power by the main power source and the sub power source; and
a sub power source controller configured to control the sub power source such that a temperature of the auxiliary heater is controlled so as to be a target temperature, wherein the sub power source controller changes the target temperature, if necessary.

It is preferable that the heating device further includes a temperature measuring device configured to measure a temperature of the heating member, wherein the sub power source controller changes the target temperature depending on the temperature of the heating member. In this case; when the temperature of the heating member is higher than a first predetermined temperature, the sub power source controller decreases the setting temperature so as to be lower than a second predetermined temperature.

Alternatively, the sub power source controller may control the sub power source to change the electric power supplied to the heating member depending on temperature change (such as temperature falling rate) of the heating member. In this case, when the temperature falling rate of the heating member is lower than a predetermined temperature falling rate, the sub power source controller controls the sub power source to decrease the electric power supplied to the heating member.

Alternatively, the sub power source controller may control the sub power source such that when the sub power source does not supply a power to the auxiliary heater and the temperature falling rate of the heating member is lower than the predetermined temperature falling rate, the sub power source controller changes the target temperature so as to be lower than the second predetermined temperature.

It is preferable that the heating device further includes an energization detecting device configured to determine an energization rate of the main heater, wherein when the energization rate of the main heater is higher than a predetermined energization rate, the sub power source controller changes the target temperature of the auxiliary heater so as to be lower than the second predetermined temperature.

It is also preferable that the heating device further includes an environmental temperature measuring device configured to measure the temperature of the environment surrounding the heating device, wherein when the environmental temperature is higher than a predetermined environmental temperature, the sub power source controller changes the target temperature of the auxiliary heater so as to be lower than the second predetermined temperature.

It is also preferable that the heating device further includes a discharge controller configured to determine whether the voltage of the capacitor of the sub power source is not lower than a minimum discharging voltage, wherein if the voltage is not lower than the minimum discharging voltage, the discharge controller discharges the capacitor to supply an electric power to the auxiliary heater. In addition, it is preferable that the heating device further includes a discharging voltage changing device configured to change setting of the minimum discharging voltage. Further, it is preferable that the heating device further includes a voltage measuring device configured to measure the voltage of the main power source, wherein when the voltage of the main power source is higher than a predetermined voltage, the discharging voltage changing device decreases the minimum discharging voltage, and when the voltage of the main power source is lower than a predetermined voltage, the discharging voltage changing device increases the minimum discharging voltage.

Alternatively, when the heating device includes the above-mentioned temperature measuring device configured to measure the temperature of the heating member and the temperature of the heating member is higher than the first predetermined temperature, the discharging voltage changing device decreases the minimum discharging voltage. When the temperature of the heating member is lower than a predetermined temperature, the minimum discharging voltage is increased.

Alternatively, when the heating device includes the above-mentioned environmental temperature measuring device configured to measure the temperature of the environment surrounding the heating device and the environmental temperature is higher than the predetermined environmental temperature, the discharging voltage changing device decreases the minimum discharging voltage. When the environmental temperature is lower than the predetermined environmental temperature, the minimum discharging voltage is increased.

Alternatively, the heating device may further include a counter configured to count a number of pieces (e.g., sheets) of the material passing through the heating member, wherein when the number of pieces of the material passing through the heating member in a last heating operation is greater than a predetermined number, the discharging voltage changing device decreases the minimum discharging voltage.

Alternatively, the heating device may further include a timer configured to measure an interval between a last heating operation and this heating operation of the heating member, wherein when the interval is longer than a predetermined time, the discharging voltage changing device decreases the minimum discharging voltage.

Alternatively, the heating device may further include a timer configured to measure a heating operation time during which one heating operation is performed (i.e., the heating member continuously heat one or more pieces of the material), wherein when the operation time is longer than a predetermined time, the discharging voltage changing device decreases the minimum discharging voltage.

It is preferable that the capacitor is an electric double layer capacitor.

As another aspect of the present invention, a fixing device is provided which includes the heating device mentioned above and a fixing member configured to fix a second material on the material by heat of the heating member of the heating device, wherein the recording material is fed through a space in the vicinity of the fixing member or is fed while contacting the fixing member, and wherein the material is a recording material.

As a yet another aspect of the present invention, an image forming apparatus is provided which includes an image forming device configured to form an image (such as toner images) on a recording material (such as papers); and the fixing device mentioned above which fixes the image on the recording material.

The features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating the cross section of an embodiment of the image forming apparatus of the present invention;

FIG. 2 is a schematic view illustrating the cross section of an embodiment of the fixing device of the present invention;

FIG. 3 is a circuit diagram of an embodiment of the heating device of the present invention;

FIG. 4 is a graph illustrating how the temperature of a fixing roller (i.e., the heating member) of the fixing device is controlled; and

FIG. 5 is a graph illustrating how the capacitor of the heating device is charged.

### DETAILED DESCRIPTION OF THE INVENTION

The present invention will be explained referring to drawings.

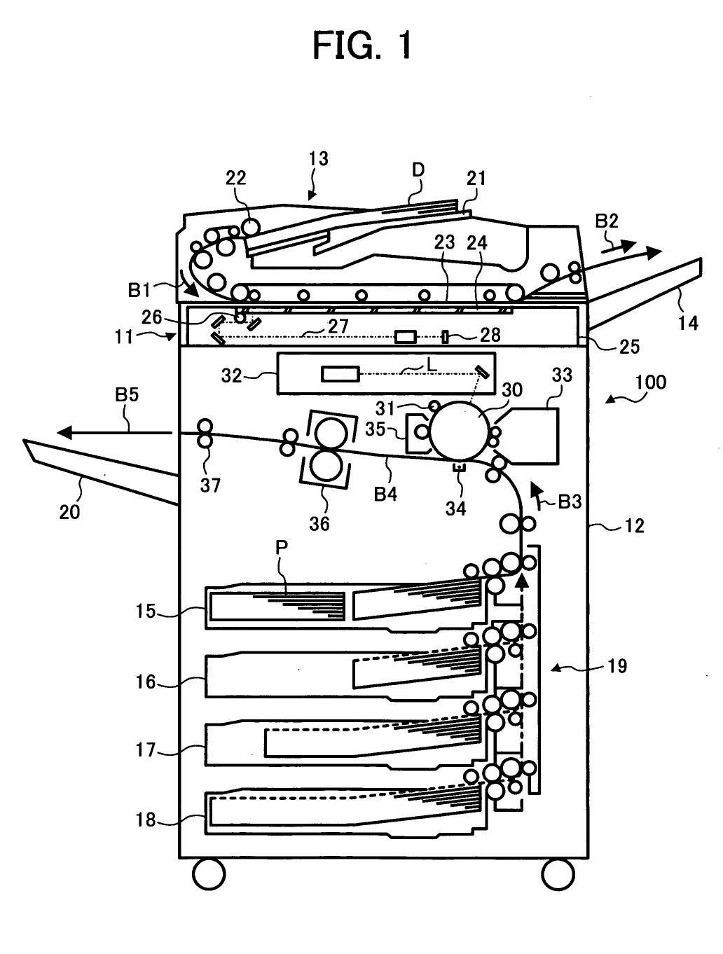

FIG. 1 is a schematic view illustrating the cross section of the image forming apparatus (e.g., copiers and printers) of the present invention. Referring to FIG. 1, numeral 100 denotes an image forming apparatus. The image forming apparatus 100 includes an image reading unit 11 configured to read an image of an original document; an image forming unit 12 configured to reproduce the original image; an automatic document feeder (ADF) 13; an original discharge tray 14; a paper feeding unit 19 including paper feeding cassettes 15-18; and a paper discharge tray 20 on which recording paper sheets bearing images thereon are stacked.

When a stack of original document sheets D is set on an original table 21 of the ADF 13 and a print key located at an operation panel (not shown) is pushed to order to copy the images of the original document sheets D, a pickup roller 22 is rotated to feed the uppermost sheet of the original document sheets D in a direction indicated by an arrow B1. The thus fed original document sheet is fed by a rotating original feeding belt 23 so as to be set on a contact glass 24 included in the image reading unit 11. The image of the original document sheet set on the contact glass 24 is read by a reading device 25 which is located between the image forming unit 12 and the contact glass 24.

The reading device 25 includes a light source 26 configured to irradiate the original document sheet D on the contact glass 24; an optical device 27 configured to form an optical image of the original image; a photoelectric transfer element 28 (e.g., charge coupled devices) on which the optical image is formed; etc. After the image reading operation is performed, the original document sheet D is fed by the original feeding belt 23 in a direction indicated by an arrow B2 to be discharged on the original discharge tray 14. Thus, the original document sheets D are fed one by one so that the image thereof are read by the image reading unit 11.

The image forming unit 12 includes a photoreceptor 30 serving as an image bearing member. The photoreceptor 30 clockwise rotates in FIG. 1. The photoreceptor 30 is charged with a charger 31 so as to have a predetermined surface potential. A writing device 32 irradiates the charged photoreceptor with laser light L, which has been modulated with the image information of the original document read by the reading device 25. Thus, an electrostatic latent image is formed on the surface of the photoreceptor 30. The electrostatic latent image formed on the photoreceptor 30 is then developed with a developing device 33 containing a developer including a toner, resulting in formation of a toner image on the photoreceptor 30. The thus prepared toner image is then transferred on a recording material P by a transfer device 34. Then the surface of the photoreceptor 30 is cleaned by a cleaning device 35.

The paper cassettes 15-18 located at a lower portion of the image forming unit 2 contain the recording materials such as papers. Any one of the uppermost sheets of the recording materials P in the paper cassettes 15-18 is fed in a direction indicated by an arrow B3 so that the toner image formed on the photoreceptor 30 is transferred on the recording material P. The sheet of the recording material P bearing the toner image thereon is then fed in a direction indicated by an arrow B4 so that the toner image is fixed on sheet of the recording material P by a fixing device 36 upon application of heat and pressure thereto. Then the sheet of the transfer material P bearing a fixed toner image thereon is fed by a pair of discharge rollers 37 in a direction indicated by an arrow B5. Thus, the sheet of the recording material D bearing the fixed toner image is discharged on the discharge tray 20. By repeating the above-mentioned image forming operations, a stack of sheets of the recording materials P, which bear reproduced original images thereon.

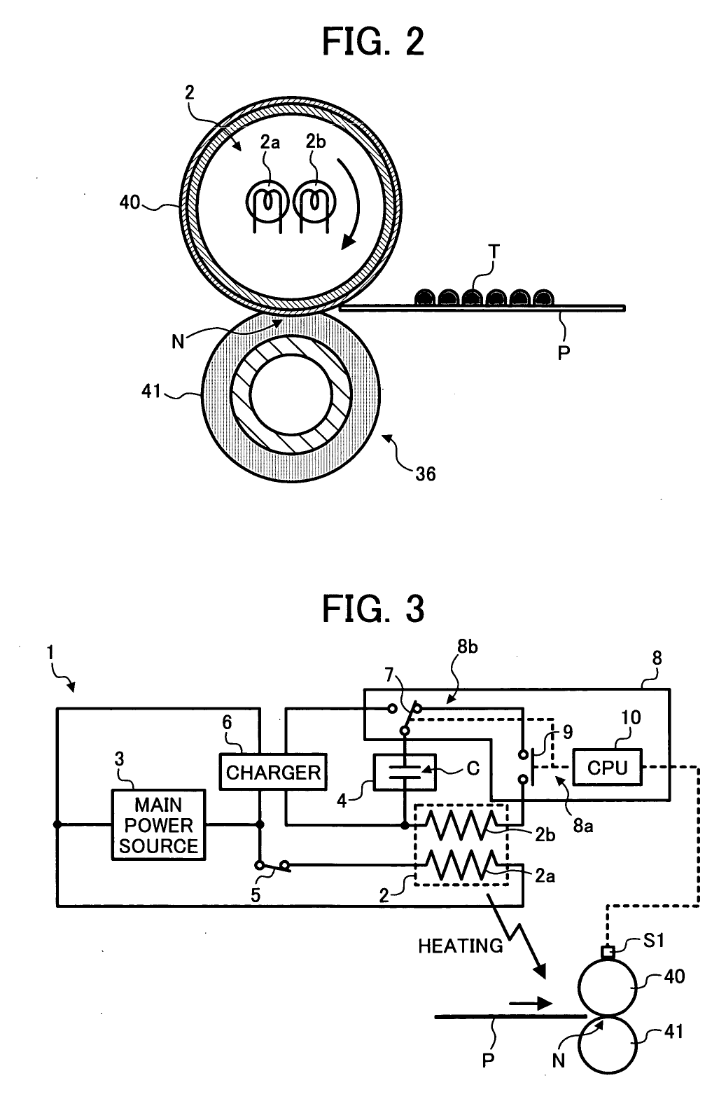

FIG. 2 is a schematic cross section of an embodiment of the fixing device 36 of the present invention, which applies heat and pressure to a sheet of the recording material P bearing a toner image T thereon to fix the toner image on a sheet of the recording material P. FIG. 3 is a circuit diagram of an embodiment of the heating device of the present invention, which is included in the fixing device 36.

The fixing device 36 has a fixing roller 40 and a pressure roller 41. For example, the fixing roller 40 of the fixing device 36 for use in an image forming apparatus which can produce images at a speed of 75 cpm (copies per minute) typically includes a fixing roller including an aluminum roller with an outside diameter of 40 mm, which includes a core having a thickness of 0.7 mm. Such a fixing roller can be heated to a fixable temperature within 30 seconds while not being damaged by a load applied to the fixing roller to form a nin N having a predetermined nip width between the fixing roller 40 and the pressure roller 41.

Conventional image forming apparatus with a copying speed of 75 cpm which do not use a sub power source typically uses a thick roller having a core with a thickness of from 5.0 mm to 10 mm as the fixing roller. However, by using a combination of such a thin roller as mentioned above and a sub power source, the rise time of the fixing roller can be drastically shortened. In addition, the fixing roller preferably includes a release layer which is made of a material such as PFA (perfluoroalkoxyethylene copolymers) and PTFE (polytetrafluoroethylene) and which is formed overlying the metal core as an outermost layer. The fixing roller 40 includes a heating member 2 including a main heater 2a and an auxiliary heater 2b, which are, for example, halogen heaters. The fixing roller 40 and the pressure roller 41 form the nip N through which the recording material P bearing a toner image is fed so that the toner image is heated and pressed to be fixed thereon.

Referring to FIG. 3, numeral 1 denotes a heating device according to the present invention. The heating device 1 includes the heating member 2, a main power source 3, a sub power source 4, a main switch 5, a charger 6, and a sub power source controller 8. In FIG. 3, the heating member 2 including the main heater 2a and the auxiliary heater 2b is located outside the fixing roller 40 for only explanation purpose. Namely, in reality the main heater 2a and the auxiliary heater 2b is located inside the fixing roller 40.

The heating member 2 includes the main heater 2a which generates heat using a power supplied by the main power source 3; and the auxiliary heater 2b which generates heat using a power supplied by the sub power source 4. The heating member 2 heats the fixing roller 40 (which is sometimes referred to as a heat receiving member). Although the details of the main power source 3 are not illustrated, the main power source 3 receives a power from a commercial power source in the image forming apparatus in which the heating device 1 is set. The main power source has a function to adjust the voltage of the power supplied from an outlet so as to be suitable for the heating member 2 to supply the adjusted power thereto. However, this function is well known, and therefore detailed description and illustration of the main power source are omitted in this application.

The sub power source 4 has a chargeable and dischargeable capacitor C. Specific examples of the capacitor C include modules in which 15 to 40 pieces of a cell having a capacitance of from 400 to 1000 F at a rated voltage of 2.5 V are serially connected to obtain the desired rated voltage and capacitance.

In order to prevent the temperature of the fixing roller (i.e., the fixing temperature) from decreasing in continuous image recording (i.e., continuous paper feeding), a capacitor in which 18 to 22 pieces of a cell having a capacitance of from 500 to 700 F are serially connected is preferably used for the fixing roller, which typically includes a heater having a rated power of from 300 to 600 w. This is because (1) the capacitor can store a power enough to heat the fixing roller for one or two minutes; and (2) even if the temperature of the fixing roller cannot be controlled by accident and in addition all the power stored in such a capacitor is further supplied to the fixing roller in a high temperature state, there is no fire risk. In addition, the capacitor has a voltage of about 50 V, and therefore there is no risk of electric shock.

In order to supply a power enough to rapidly raise the fixing temperature at the rise time, it is preferable that a heater having, for example, a rated power of from 800 to 1000 w is connected in parallel with the sub power source. In this case, a total power of from 1600 to 2000 w is supplied. Therefore it is preferable to use a capacitor in which 36 to 44 pieces of a cell having a capacitance of from 500 to 700 F are serially connected. This is because (1) a capacity and a voltage enough to supply a power for about ten seconds can be stored and (2) even in continuous image recording, decrease of the fixing temperature can be prevented by using only one of the heaters.

Under a real operating condition, the capacitor is charged so as to have a target voltage which is lower than the rated voltage thereof. This is because the reliability of the capacitor can be improved while considering the variations of the voltage circuit and durability of the capacitor cells. It is possible to use a module in which cells having a relatively low capacitance of about 100 F are connected in parallel. However, it is preferable to connect all cells in series because the number of electric circuits used for each cell can be reduced and a problem of the cells can be rapidly detected if any.

The reason why capacitors such as electric double layer capacitors are used for the heating device of the present invention is that capacitors are superior to secondary batteries because of supplying a power without inducing a chemical reaction.

As mentioned above, when a conventional nickel-cadmium battery serving as a secondary battery is used for the sub power source, it takes a long time of from tens minutes to few hours to charge the secondary battery even when rapid charging is performed. In contrast, the sub power source 4 using a capacitor can be rapidly charged in a time of about few minutes. When the fixing device repeatedly achieves a waiting state and a heating state, the sub power source 4 including the capacitor supplies a power for heating the heating member 2. Thus, the temperature of the heating member 2 can be rapidly increased to the predetermined temperature.

In addition, nickel cadmium batteries expire their life when charging and discharging are repeated from 500 to 1000 times. Namely, nickel cadmium batteries have too short a life to be used for the sub power source for heating, and have drawbacks in that the batteries have to be frequently replaced with new one, which is troublesome, and the running costs are high.

In contrast, the sub power source using an electric double layer capacitor has a life such that charging and discharging can be repeated several million times. In addition, the sub power source does not deteriorate even when charging and discharging are repeatedly performed many times. Further, the sub power source has an advantage in maintenance property such that operations such as replacement or replenishment of a liquid, which are necessary for lead batteries, are not needed. Therefore, the sub power source can be stably used for a long period of time.

Electric double layer capacitors do not use a dielectric material and utilize adsorption and desorption reaction (i.e., charging and discharging) of an ion adsorption layer of an electric double layer in which ion or charges of solvent molecules are concentrated and which is formed at an interface between a solid electrode and a solution. Therefore, the capacitors have the following advantages:
(1) charging and discharging can be repeated many times, i.e., the capacitors have a long life;
(2) being free from maintenance;
(3) being friendly to environment; and
(4) charging and discharging efficiency is high.

Recently, high-capacity electric double layer capacitors having a capacitance of tens of thousand farad and an energy density of tens w h/kg have been developed.

The main switch 5 turns on and off the power supplied by the main power source 3 to the main heater 2a. The charger 6 has a function of changing the voltage of the power supplied from the main power source 3 while rectifying (i.e., changing alternate current to direct current) so as to be suitable for the sub power source 4 to charge the capacitor C of the sub power source 4.

The sub power source controller 8 includes a switch 7, another switch 9 and a CPU 10, and serves as a discharge controller 8a and a charge controller 8b. The discharge controller 8a switches from charging the sub power source 4 to supplying a power to the auxiliary heater 2b, or vice versa. The switching conditions will be explained later.

The charge controller 8b has a function of turning on and off the power supplied to the auxiliary heater 2b from the sub power source 4. The switching conditions will be explained later. The controller 8 illustrated in FIG. 3 is merely an embodiment, and only a portion of the controller, which is configured to control the heating member 2, is illustrated. Needless to say, a controller controlling the entire image forming apparatus or the like controller can be used as the sub power source controller 8. In addition, the electrical connection for controlling the sub power source 4 is not limited to that illustrated in FIG. 3.

Hereinafter, the basic operation of the heating device 1 will be explained. When the heating device 1 is in a waiting state, the switch 7 connects the charger 6 to the sub power source 4 to charge the capacitor C of the sub power source 4. In this case, when it is desired to heat the heating member 2, the main switch 5 is activated to supply a power to the main heater 2a from the main power source 3 and the switch changes the connection, thereby supplying a large amount of power to the heating member 2. Thus, a large amount of power is supplied to the heating member 2 by both the main power source 3 and the sub power source 4 in the start-up time, and thereby the temperature of the heating member 2 can be rapidly raised to the predetermined temperature.

When a predetermined time passes after a power is supplied to the auxiliary heater 2a of the heating member 2 by the sub power source 4, the sub power controller 8 stops the power supplied from the sub power source 4 to the auxiliary heater 2b to prevent overheating of the heating member 2, i.e., to control the temperature of the heating member 2 so as to be a predetermined temperature. The power supplied from the sub power source 4 to the auxiliary heater 2b gradually decreases with time. In this case, it is preferable that the time at which the power supplied from the sub power source 4 to the auxiliary heater 2b is stopped is determined depending on the degree of reduction in the supplied power. Namely, it is preferable that when the supplied power is reduced to some degree, the power supply is stopped. By using this method, problems such as deterioration of parts used for the circuits of the heating device 1 and generation of electromagnetic noises, which are caused when application of a large amount of electric power is suddenly stopped, can be avoided.

The recording material P bearing the toner image T thereon is fed to the nip N between the fixing roller 40 heated to a predetermined temperature and the pressure roller 41 in the fixing device 36, wherein the toner image T is heated, melted, and fixed on the recording material P. Thus, a fixed toner image is formed on the recording material P. In this case, the main power source 3 and the sub power source 4 supply power to the main heater 2a and the auxiliary heater 2b of the heating member 2 of the fixing roller 40 to heat the fixing roller 40 while performing on/off controlling of the power supplied from the sub power source 4 to prevent overheating of the fixing roller 40. Thus, the fixing temperature is controlled so as to be a predetermined temperature or so as to fall in a predetermined temperature range, and thereby the toner image T can be stably heated and fused, resulting in formation of toner images with good image qualities on the recording material P. In addition, power is supplied to the main heater 2a and the auxiliary heater 2b, which are located inside the fixing roller 40, from the main power source 3 and the sub power source 4, and thereby the temperature of the surface of the fixing roller 40 can be rapidly raised to the predetermined fixing temperature.

Then an embodiment of the image forming apparatus of the present invention will be explained.

In this embodiment, the sub power source controller 8 controls the operations of the sub power source 4 as follows. When the sub power source controller 8 judges from consideration of various conditions that the temperature of the heating member 2 is not decreased even if the auxiliary heater 2b does not heat the heating member 2, the controller 8 stops the power supplied from the capacitor C to the auxiliary heater 2b.

Specifically, in the present embodiment, the temperature of the fixing roller 40, which is a substitute of the temperature of the heating member 2, is measured with a temperature sensor S1 as illustrated in FIG. 2. When the decreasing rate of the temperature of the fixing roller 40 is lower than a predetermined decreasing rate, the criterion for on/off controlling of the switch 9 of the sub power source controller 8 is changed.

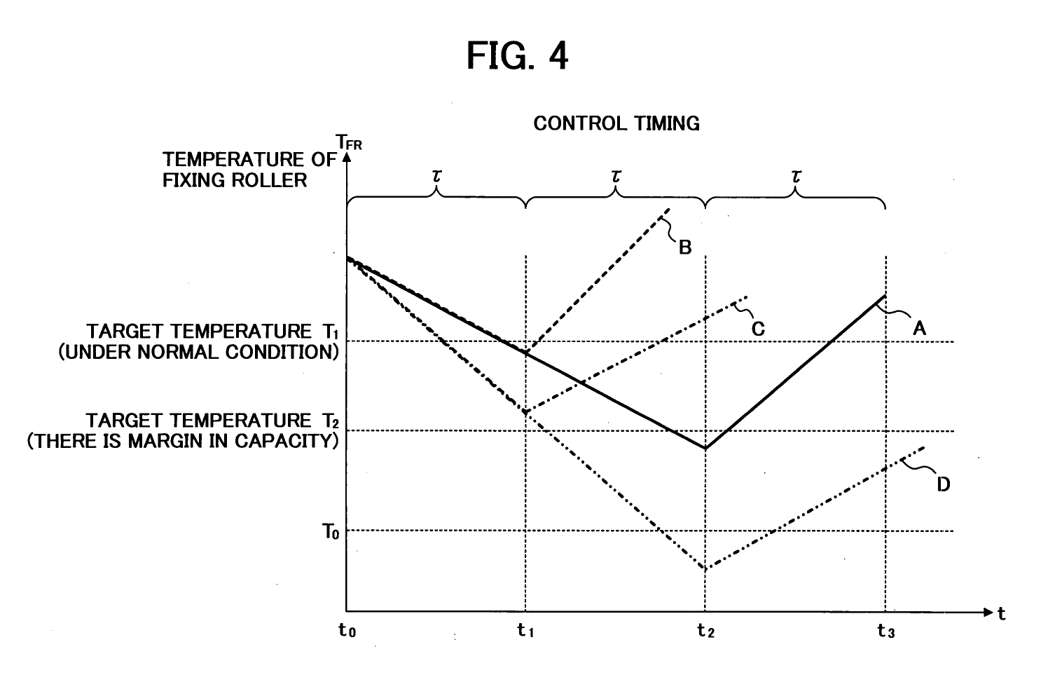

FIG. 4 is a graph showing the temperature of the fixing roller of the image forming apparatus. The target temperature T₁ of the auxiliary heater 2b represents the target temperature of the fixing roller under normal conditions (i.e., in a case where the temperature of the fixing roller 40 seriously decreases, namely the gradient of the line is sharp). In contrast, the target temperature T2 represents the target temperature of the fixing roller 40 in a case where the main power source has an enough power for heating. Specifically, the decreasing rate of the temperature of the fixing roller 40 is slower than the threshold value (i.e., the gradient of the line is gentle). In this case, when the temperature T_{FR} of the fixing roller is not so decreased, a power is not supplied to the auxiliary heater 2b. This is because the decrease of the temperature of the fixing roller 40 in such degree does not cause any problem.

Referring to FIG. 4, τ represents the controlling timing, to represents a time at which a power is supplied only from the main power source 3 to the heating member 2 when the temperature of the fixing roller 40 is not lower than a minimum fixable temperature T₀. In addition, the degree of decrease in the temperature of the fixing roller 40 is small (as illustrated by a line A, hereinafter referred to a case A). In this case, the sub power source controller 8 changes the target temperature from T₁ to T₂. A power is supplied by the sub power source 4 to the heating member 2 at a time t₂. Namely, the temperature of the fixing roller 40 is controlled along the line A. Thus, even when the temperature controlling is performed at a relatively long intervals of r, the temperature of the fixing roller 40 never becomes lower than the minimum fixable temperature T₀. In addition, the fixing temperature can be controlled while the temperature curve has a small ripple. The temperatures T₁ and T₂ are determined so as to be suitable for the image forming apparatus, for example, by experiments.

In FIG. 4, a broken line B represents a case where the degree of the temperature fall of the fixing roller is as small as that in the case A. In this case, the target temperature at which a power is supplied from the sub power source 4 to the heat member 2 is fixed to the temperature T₁. Since the temperature of the fixing roller 40 is lower than the target temperature T₁ at a time t₁, a power is supplied from the sub power source 4 to the heat member 2 at the time t₁. Therefore, the temperature of the fixing roller 40 is increased as illustrated by the line B. In this case, the temperature of the fixing roller 40 is excessively increased, and the capacitor is used more frequently.

In FIG. 4, a dashed line C represents a case where the degree of the temperature fall of the fixing roller is larger than that in the case A. In this case C, the target temperature is fixed to the temperature T₁. Since the temperature of the fixing roller 40 is lower than the target temperature T₁ at the time t₁, a power is supplied from the sub power source 4 to the heat member 2 at the time t₁. Therefore, the temperature of the fixing roller 40 is increased as illustrated by the line C. In this case, the time during which a power is supplied from the sub power source 4 is excessively long, i.e., the capacitor is used for a long time.

In FIG. 4, a chain double-dashed line D represents a case where the degree of the temperature fall of the fixing roller is larger than that in the case A and the same as that of the case C. In this case D, the target temperature is fixed to the temperature T₂. Since the temperature of the fixing roller 40 is lower than the target temperature T₂ at the time t₂, a power is supplied from the sub power source 4 to the heat member 2 at the time t₂. Therefore, the temperature of the fixing roller 40 is increased as illustrated by the line D. In this case, the temperature of the fixing roller 40 is controlled while the temperature curve has a large ripple, and a problem in that the temperature of the fixing roller becomes lower than the minimum fixing temperature T₀, resulting in formation of an unfixed toner image occurs.

As mentioned above, by controlling the temperature of the fixing roller 40 by the method used for the case A (where there is margin in capacity) and the case C (normal condition), the temperature is well controlled without frequently using the capacitor C. Therefore, the load to the sub power source 4 can be decreased, and thereby the life of the sub power source 4 can be lengthened.

The above-mentioned embodiment uses a temperature controlling method in which a time at which the sub power source controller 8 determines to supply a power from the sub power source 4 is determined while the temperature of the heating member 2 (i.e., the temperature of the fixing roller 40) is monitored. However, the temperature controlling method is not limited thereto, and the following other temperature controlling methods can also be used.

One of the other methods is that the temperature controlling is performed while the target temperature is changed by the sub power source controller 8 depending on the temperature decreasing conditions of the heating member 2.

Another method is that the temperature controlling is performed while checking the energization rate of the main heater caused by the main power source 3 (i.e., checking how often the main heater 2a is energized) with an energization detector. When the energization rate of the main heater 2a is relatively high compared to a predetermined rate, the sub power source controller 8 considers that the main power source 3 has a margin in capacity, and controls such that the target temperature of the fixing roller 40 is changed.

Alternatively, it is possible to measure the voltage of the main power source 3 to determine whether the main power source is activated (i.e., whether the main heater 2a is energized). When the voltage is higher than a predetermined value, the sub power source controller 8 controls such that the target temperature of the fixing roller 40 is changed.

Alternatively, it is possible to measure the environmental temperature of the environment surrounding the heat member 2 with an environmental temperature measuring device. When the environmental temperature is higher than a predetermined temperature, the sub power source controller decreases the target temperature.

Then another embodiment of the image forming apparatus of the present invention will be explained in detail.

In this embodiment, the minimum discharging voltage of the capacitor C is changed by a discharging voltage changing device 8b to shorten the charging time of the capacitor C. However, the minimum discharging voltage is not merely changed, and is changed depending on the information on the conditions of the heating device 1, the fixing device 36 and the image forming apparatus 100, such as temperature thereof.

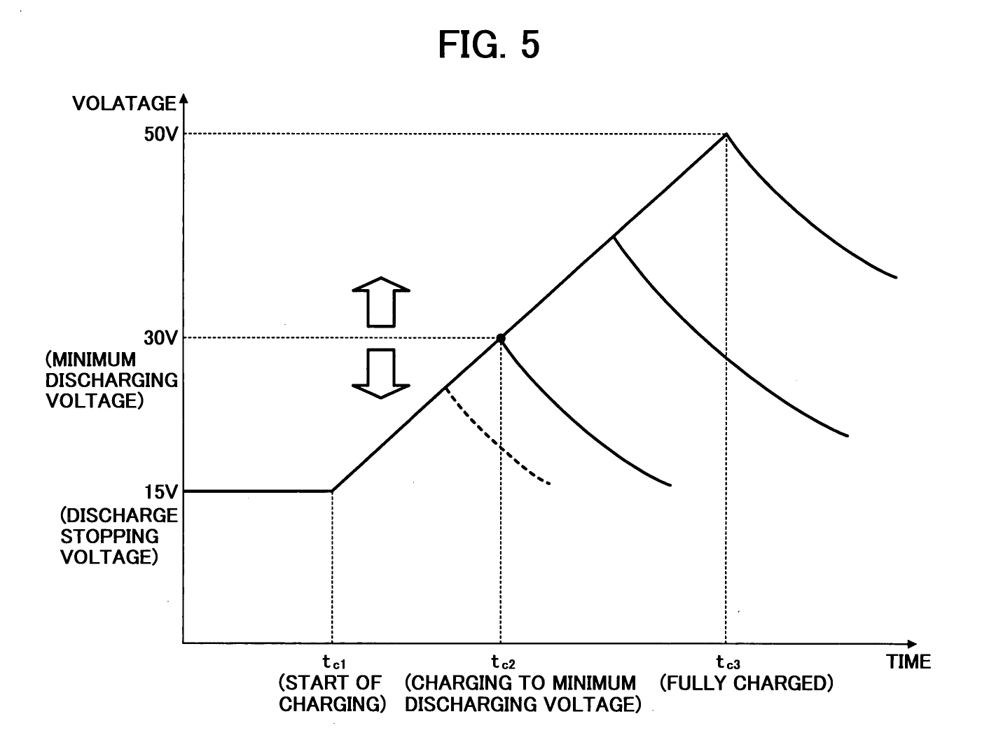

FIG. 5 is a graph showing the change of voltage of the capacitor C due to charging of the capacitor during a time period from the charge starting time to the charge completion time, and discharging thereof. The capacitor C used for this experiment has a voltage of 50 V when fully charged. In addition, when the voltage of the capacitor rises to a minimum discharging voltage (for example, 30 V in FIG. 5), the capacitor has a discharging ability. Further, when the voltage decreases to a discharge stopping voltage (for example, 15 V in FIG. 5), the capacitor stops discharging. The full charge voltage, the minimum discharging voltage and the discharge stopping voltage are not limited thereto, and, for example, the following conditions are also possible.
Full charge voltage: 45 V
Minimum discharging voltage: 32 V
Discharge stopping voltage: 20 V

In addition, the time between a charge starting time tc₁ to a minimum discharging voltage charging time tc₂ and the time between the charge starting time tc₁ to a charge completion time tc₃ are less than 1 minute, and less than 2 minutes (from 1 to 1.5 minutes), respectively, in this experiment. However, the times are not limited thereto.

The discharging voltage of the capacitor C can be changed depending on the information on, for example, the voltage of the main power source 3. Suitable voltage measuring devices for use in measuring the voltage of the main power source 3 include known voltage measuring devices. The sub power source controller 8 changes the minimum discharging voltage of the capacitor C depending on the voltage of the main power source detected.

For example, when the voltage of the main power source 3 is greater than a predetermined voltage, the minimum discharging voltage of the capacitor C is set so as to be relatively low. This is because if the voltage is high, the amount of the power supplied by the main power source 3 is considered to be large, and therefore, the amount of power supplied to the auxiliary heater 2b can be decreased. Therefore, it is preferable that the minimum dischargeable voltage at which discharging of the capacitor is permitted is changed. Specifically, when there is no problem if the amount of the power supplied to the capacitor is small, the minimum discharging voltage is lowered, thereby shortening the charging time of the capacitor C. In this regard, shortening of the charging time does not mean shortening of the full charging time of the capacitor, and means that the capacitor on the way of charging is discharged to shorten the charging time.

In contrast, when the voltage of the main power source 3 is lower than the predetermined voltage, the minimum discharging voltage is set so as to be relatively high. This is because if the voltage is low, the amount of the power supplied by the main power source 3 is considered to be small, and therefore, the amount of power supplied to the auxiliary heater 2b is preferably increased to rapidly raise the temperature of the fixing roller 40 and not to cause formation of an unfixed toner image at the fixing device 36. Such a controlling method can be used whether the main power source 3 is an AC power source or a DC power source. It is preferable that the predetermined voltage is previously determined, for example, by experiments.

Alternatively, the minimum discharging voltage may be changed depending on the temperature of the pressure roller 41 which is pressing-contact with the fixing roller 40. Suitable temperature measuring devices for use in measuring the temperature of the pressure roller 41 include known temperature sensors. In this case, the sub power source controller 8 changes the target of the minimum discharging voltage of the capacitor C depending on the temperature of the pressure roller 41.

For example, when the temperature of the pressure roller 41 is higher than a predetermined temperature, the minimum discharging voltage is set so as to be relatively low. For example, when the image forming operation is continuously performed in the image forming apparatus 100, the temperature of the pressure roller 41 is increased. In this case, the heat of the fixing roller 40 is hardly absorbed by the pressure roller 41, and therefore, there is no problem even when the amount of the power supplied to the auxiliary heater 2b by discharging the capacitor C is small. Therefore, it is preferable that the minimum discharging voltage is changed. Specifically, when there is no problem if the amount of the power supplied to the capacitor is small, the minimum discharging voltage is lowered, thereby shortening the charging time of the capacitor C.

In contrast, when the temperature of the pressure roller 41 is lower than the predetermined temperature, the minimum discharging voltage is increased to increase the amount of the power which is caused by discharging and is supplied to the auxiliary heater 2b. Thus, a problem in that almost all the heat of the fixing roller 40 is consumed for raising the temperature of the pressure roller 41 and thereby an unfixed toner image is formed by the fixing device can be avoided.

Alternatively, the minimum discharging voltage of the capacitor C can be changed depending on the environmental temperature of the heating device 1, the fixing device 36 or the image forming apparatus 100. For example, the minimum discharging voltage can be changed depending on the temperature of the nip between the fixing roller 40 and the pressure roller 41. Since it is difficult to measure the temperature of the nip, the temperature of the inside or outside of the heating device 1, the fixing device 36 and the image forming apparatus 100 may be measured instead of the temperature of the nip. The sub power source controller 8 changes the minimum discharging voltage depending on the environmental temperature. In this regard, the information according which the minimum discharging voltage is changed is not limited to the environmental temperature, and any other information which relate to (or influence) fixing of toner images can be used therefor.

For example, when the environmental temperature is higher than a predetermined temperature, the minimum discharging voltage of the capacitor is set so as to be relatively low to shorten the charging time. In contrast, when the environmental temperature is lower than a predetermined temperature, the minimum discharging voltage of the capacitor C is set so as to be relatively high to supply a large amount of power. Specifically, when the environmental temperature is high, the fixing problem is hardly caused even when the amount of the power supplied to the capacitor C is small. When the environmental temperature is low, the amount of the power supplied to the capacitor C is increased by increasing the voltage of the capacitor C, resulting in prevention of occurrence of the fixing problem.

Alternatively, the minimum discharging voltage of the capacitor C can be changed depending on the number of sheets of the recording material fed through the fixing device in the last image forming operation. Suitable detectors for use in counting the number of sheets of the recording material include known devices such as counters. The sub power source controller 8 changes the minimum discharging voltage of the capacitor C depending on the number of sheets of the recording material fed through the fixing device in the last image forming operation.

For example, when the number of recording material sheets fed through the fixing device in the last image forming operation is greater than a predetermined number, the minimum discharging voltage of the capacitor C is set so as to be relatively low. This is because when a large number of sheets are fed through the fixing device in the last image forming operation, the temperature of the pressure roller is increased. Therefore, the amount of power supplied from the capacitor C to the auxiliary heater 2b can be decreased similarly to the above-mentioned case where the minimum discharging voltage is changed depending on the temperature of the pressure roller. Thus, the charging time of the capacitor can be shortened. In contrast, when the number of recording material sheets fed through the fixing device in the last image forming operation is less than a predetermined number, the minimum discharging voltage of the capacitor C is set so as to be relatively high.

Alternatively, the minimum discharging voltage of the capacitor C can be changed depending on the image forming interval between the present image fixing operation of the fixing device and the last image forming operation thereof. Suitable devices for use in determining the image forming interval include known devices such as timers. The sub power source controller 8 changes the minimum discharging voltage of the capacitor C depending on the image forming interval.

For example, when the image forming interval is shorter than a predetermined interval, the minimum discharging voltage of the capacitor C is set so as to be relatively low. This is because when the interval is relatively short, the temperature of the pressure roller 41 is increased. Therefore, similarly to the case mentioned above, the amount of the power supplied to the auxiliary heater 2b can be decreased, resulting in shortening of the charging time of the capacitor C.

Alternatively, the minimum discharging voltage of the capacitor C can be changed depending on the operating time of the last fixing operation of the fixing device 36. Suitable devices for use in determining the operating time include known devices such as timers. The sub power source controller 8 changes the minimum discharging voltage of the capacitor C depending on the operating time of the last fixing operation.

For example, when the operating time of the last fixing operation is longer than a predetermined operating time, the minimum discharging voltage of the capacitor C is set so as to be relatively low. This is because when the operating time is relatively long, the temperature of the pressure roller 41 is increased. Therefore, similarly to the case mentioned above, the amount of the power supplied to the auxiliary heater 2b can be decreased, resulting in shortening of the charging time of the capacitor C.

The above-mentioned methods for changing the minimum discharging voltage can be used alone or in combination. In addition, changing the discharging voltage is controlled by the sub power source controller included in the heating device 1 in the above-mentioned methods, but the present invention is not limited thereto. For example, the fixing device 36 or the image forming apparatus 100 of the present invention can include a controller controlling changing of the minimum discharging voltage. Further, in any cases, the controller may be a special controller configured to control only changing of the minimum discharging voltage or a multi-purpose controller configured to control not only changing of the minimum discharging voltage but also other operations.

In addition, in the above-mentioned embodiments, the nip N is formed by the two rollers, i.e., the fixing roller 40 and the pressure roller 41. However, the fixing device is not limited thereto, and fixing devices in which a nip is formed by a combination of a roller and a belt or a combination of two belts can also be used. In addition, the recording material P can be fed while contacting a heating member or passing a space in the vicinity of a heating member.

The image forming apparatus of the present invention is not limited to that illustrated in FIG. 1. For example, image forming apparatus using a belt-form photoreceptor and color image forming apparatus using an intermediate transfer medium can also be included in the image forming apparatus of the present invention.

Effect of the Present Invention

In the present invention, the target temperature of an auxiliary heater is changeable. When the target temperature is relatively low, the power supplied from the sub power source is decreased by decreasing the minimum discharging voltage of a capacitor. By using this method, the duty of the capacitor can be decreased, and thereby the capacitor is efficiently and optimally used.

This document claims priority and contains subject matter related to Japanese Patent Application No. 2003-408694, filed on Dec. 8, 2003, incorporated herein by reference.

Having now fully described the invention, it will be apparent to one of ordinary skill in the art that many changes and modifications can be made thereto without departing from the spirit and scope of the invention as set forth therein.

1. A heating device comprising:
a main power source;
a sub power source comprising a capacitor capable of charging and discharging;
a heating member comprising a main heater and an auxiliary heater and configured to heat a material with the heater and the auxiliary heater, wherein the main heater and the auxiliary heater are supplied with electric power by the main power source and the sub power source; and
a sub power source controller configured to control the sub power source such that a temperature of the auxiliary heater is controlled so as to be a target temperature, wherein the sub power source controller changes the target temperature, if necessary.

2. The heating device according to claim 1, further comprising:
a temperature measuring device configured to measure a temperature of the heating member,
wherein the sub power source controller changes the target temperature depending on the temperature of the heating member.

3. The heating device according to claim 2, wherein when the temperature of the heating member is higher than a first predetermined temperature, the sub power source controller decreases the target temperature so as to be lower than a second predetermined temperature.

4. The heating device according to claim 2, wherein the sub power source controller controls the sub power source to change the electric power supplied from the sub power source to the heating member depending on temperature change of the heating member.

5. The heating device according to claim 4, wherein the sub power source controller controls the sub power source to decrease the electric power supplied from the sub power source to the heating member when a temperature falling rate of the heating member is lower than a predetermined temperature falling rate.

6. The heating device according to claim 2, wherein the sub power source controller controls such that when the sub power source does not supply the electric power to the auxiliary heater and a temperature falling rate of the heating member is lower than a predetermined temperature falling rate, the target temperature is controlled so as to be lower than a predetermined temperature.

7. The heating device according to claim 1, further comprising:
an energization detecting device configured to determine an energization rate of the main heater,
wherein when the energization rate of the main heater is higher than a predetermined energization rate, the sub power source controller controls the target temperature of the auxiliary heater so as to be lower than a predetermined temperature.

8. The heating device according to claim 1, further comprising:
an environmental temperature measuring device configured to measure a temperature of an environment surrounding the heating device,
wherein when the environmental temperature is higher than a predetermined environmental temperature, the sub power source controller controls the target temperature of the auxiliary heater so as to be lower than a predetermined temperature.

9. The heating device according to claim 1, further comprising:
a discharge controller configured to determine whether a voltage of the capacitor of the sub power source is not lower than a minimum discharging voltage, wherein if the voltage is not lower than the minimum discharging voltage, the discharge controller discharges the capacitor to supply an electric power to the auxiliary heater.

10. The heating device according to claim 9, further comprising:
a discharging voltage changing device configured to change setting of the minimum discharging voltage.

11. The heating device according to claim 10, further comprising:
a voltage measuring device configured to measure a voltage of the main power source,
wherein when the voltage of the main power source is higher than a predetermined voltage, the discharging voltage changing device decreases the minimum discharging voltage, and when the voltage of the main power source is lower than the predetermined voltage, the discharging voltage changing device increases the minimum discharging voltage.

12. The heating device according to claim 10, further comprising:
a temperature measuring device configured to measure a temperature of the heating member,
wherein when the temperature of the heating member is higher than a predetermined temperature, the discharging voltage changing device decreases the minimum discharging voltage, and when the temperature of the heating member is lower than the predetermined temperature, the discharging voltage changing device increases the minimum discharging voltage.

13. The heating device according to claim 10, further comprising:
an environmental temperature measuring device configured to measure a temperature of an environment surrounding the heating device,
wherein when the environmental temperature is higher than a predetermined environmental temperature, the discharging voltage changing device decreases the minimum discharging voltage, and when the environmental temperature is lower than the predetermined environmental temperature, the discharging voltage changing device increases the minimum discharging voltage.

14. The heating device according to claim 10, further comprising:
a counter configured to count a number of pieces of the material passing through the heating member,
wherein when the number of pieces of the material passing through the heating member in a last heating operation is greater than a predetermined number, the discharging voltage changing device decreases the minimum discharging voltage.

15. The heating device according to claim 10, further comprising:
a timer configured to measure an interval between a last heating operation and this heating operation of the heating member,
wherein when the interval is longer than a predetermined time, the discharging voltage changing device decreases the minimum discharging voltage.

16. The heating device according to claim 10, further comprising:
a timer configured to measure a heating operation time during which the heating member continuously heat one or more pieces of the material,
wherein when the heating operation time is longer than a predetermined time, the discharging voltage changing device decreases the minimum discharging voltage.

17. The heating device according to claim 1, wherein the capacitor is an electric double layer capacitor.

18. A fixing device comprising:
the heating device according to claim 1; and
a fixing member configured to fix a second material on a recording material by heat of the heating member of the heating device, wherein the recording material bearing the second material thereon passes while contacting the fixing member or passes through a space in the vicinity of the fixing member.

19. The fixing device according to claim 18, further comprising:
a counter configured to count a number of sheets of the recording material passing while contacting the fixing member or passing through a space in the vicinity of the fixing member;
a discharge controller configured to determine whether a voltage of the capacitor of the sub power source is not lower than a minimum discharging voltage, wherein if the voltage is not lower than the minimum discharging voltage, the discharge controller discharges the capacitor to supply an electric power to the auxiliary heater; and
a discharging voltage changing device configured to change setting of the minimum discharging voltage,
wherein the discharging voltage changing device changes the minimum discharging voltage depending on the number of sheets of the recording material fed in a last heating operation.

20. The fixing device according to claim 19, wherein when the number of sheets of the recording material fed in the last heating operation is greater than a predetermined number, the discharging voltage changing device decreases the minimum discharging voltage.

21. The fixing device according to claim 18, further comprising:
a timer configured to measure an interval between a last heating operation and this heating operation of the heating member;
a discharge controller configured to determine whether a voltage of the capacitor of the sub power source is not lower than a minimum discharging voltage, wherein if the voltage is not lower than the minimum discharging voltage, the discharge controller discharges the capacitor to supply an electric power to the auxiliary heater; and
a discharging voltage changing device configured to change setting of the minimum discharging voltage,
wherein the discharging voltage changing device changes the minimum discharging voltage depending on the interval between the last heating operation and this heating operation.

22. The fixing device according to claim 21, wherein when the interval between the last heating operation and this heating operation is longer than a predetermined interval, the discharging voltage changing device decreases the minimum discharging voltage.

23. The fixing device according to claim 18, further comprising:
a timer configured to measure a heating operation time during which the fixing member continuously heats one or more sheets of the recording material;
a discharge controller configured to determine whether a voltage of the capacitor of the sub power source is not lower than a minimum discharging voltage, wherein if the voltage is not lower than the minimum discharging voltage, the discharge controller discharges the capacitor to supply an electric power to the auxiliary heater; and
a discharging voltage changing device configured to change setting of the minimum discharging voltage,
wherein the discharging voltage changing device changes the minimum discharging voltage depending on the heating operation time.

24. The fixing device according to claim 23, wherein when the heating operation time is longer than a predetermined time, the discharging voltage changing device decreases the minimum discharging voltage.

25. An image forming apparatus comprising:
an image forming device configured to form an image on a recording material; and
a fixing device configured to fix the image on the recording material,
wherein the fixing device is the fixing device according to claim 18.

26. The image forming apparatus according to claim 25, further comprising:
a counter configured to count a number of sheets of the recording material fed while contacting the fixing member or fed through a space in the vicinity of the fixing member;
a discharge controller configured to determine whether a voltage of the capacitor of the sub power source is not lower than a minimum discharging voltage, wherein if the voltage of the capacitor is not lower than the minimum discharging voltage, the discharge controller discharges the capacitor to supply an electric power to the auxiliary heater; and
a discharging voltage changing device configured to change setting of the minimum discharging voltage,
wherein the discharging voltage changing device changes the minimum discharging voltage depending on the number of sheets of the recording material fed in a last heating operation.

27. The image forming apparatus according to claim 26, wherein when the number of sheets of the recording material in the last heating operation is greater than a predetermined number, the discharging voltage changing device decreases the minimum discharging voltage.

28. The image forming apparatus according to claim 25, further comprising:
a timer configured to measure an interval between a last heating operation and this heating operation of the heating member;
a discharge controller configured to determine whether a voltage of the capacitor of the sub power source is not lower than a minimum discharging voltage, wherein if the voltage of the capacitor is not lower than the minimum discharging voltage, the discharge controller discharges the capacitor to supply an electric power to the auxiliary heater; and
a discharging voltage changing device configured to change setting of the minimum discharge voltage,
wherein the discharging voltage changing device changes the minimum discharging voltage depending on the interval between the last heating operation and this heating operation.

29. The image forming apparatus according to claim 28, wherein when the interval between the last heating operation and this heating operation is longer than a predetermined interval, the discharging voltage changing device decreases the minimum discharging voltage.

30. The image forming apparatus according to claim 25, further comprising:
a timer configured to measure a heating operation time during which the fixing member continuously heats one or more sheets of the recording material;
a discharge controller configured to determine whether a voltage of the capacitor of the sub power source is not lower than a minimum discharging voltage, wherein if the voltage of the capacitor is not lower than the minimum discharging voltage, the discharge controller discharges the capacitor to supply an electric power to the auxiliary heater; and
a discharging voltage changing device configured to change setting of the minimum discharge voltage,
wherein the discharging voltage changing device changes the minimum discharging voltage depending on the heating operation time.

31. The image forming apparatus according to claim 30, wherein when the heating operation time is longer than a predetermined time, the discharging voltage changing device decreases the minimum discharging voltage.
